(19) United States
(12) Patent Application Publication
(10) Pub. No.: US 2006/0050423 A1
(43) Pub. Date: Mar. 9, 2006

(54) Exterior rearview mirror for vehicles, preferably for motor vehicles

(75) Inventors: Florin Secanu, Nurtingen (DE); Bernd Waldmann, Nurtingen (DE); Karl-Heinz Leonberger, Hochdorf (DE); Alexander Pirner, Esslingen (DE)

Correspondence Address: Warn, Hoffmann, Miller & LaLone, P.C., P.O. Box 70098, Rochester Hills, MI, 48307, US

(73) Assignee: Schefenacker Vision Systems Germany GmbH, Esslingen (DE)

(21) Appl. No.: 11/217,173

(22) Filed: Sep. 1, 2005

(30) Foreign Application Priority Data
Sep. 6, 2004 (DE) 102004042903.0

(51) Int. Cl. G02B 7/182

(52) U.S. Cl. 359/871; 359/841

(57) ABSTRACT

Exterior rearview mirror for vehicles, preferably for motor vehicles. The exterior rearview mirror has a mirror base, and a mirror body, which can be folded relative to the mirror base and which has a housing. The housing of the mirror body is approximately rectangular when viewed from the side. It is connected to the laterally projecting part of the mirror base in the corner region of the housing. In order to design the exterior rearview mirror such that it is problem-free in use, the housing transitions through a narrow section into a connecting part to the mirror base. The mirror body is mounted on the mirror base by means of this connecting part. Consequently, the overall height of the mirror base can be kept very small. The narrow section of the mirror body prevents wind noises from occurring, since the slip stream can easily flow past the narrow section without catching on parts of the exterior rearview mirror. The exterior rearview mirror has a favorable aerodynamic design, and has a light and small appearance because of the narrow section.

### CROSS-REFERENCE TO RELATED APPLICATIONS

This application claims priority to German Patent Application No. 10 2004 042 903.0 filed on Sep. 6, 2004.

### TECHNICAL FIELD

The invention concerns an exterior rearview mirror for vehicles, preferably for motor vehicles.

### BACKGROUND

In exterior rearview mirrors the mirror base that is affixed to the side of the vehicle is approximately L-shaped in design. The housing of the mirror body is supported in a folding manner on the laterally projecting arm of the mirror base. The housing of the mirror body is approximately rectangular when viewed from the side. The housing of the mirror body is connected to the laterally projecting part of the mirror base in the corner region of the housing. As a result of this design, wind noises arise during travel, which are sometimes so intense they are perceived as bothersome by the driver.

The object of the invention is to design an exterior rearview mirror such that it is substantially problem-free in use.

This object is attained in accordance with the present invention in an exterior rearview mirror.

### SUMMARY

In the inventive exterior rearview mirror, the housing of the mirror body is provided with a narrow section through which the housing transitions into the connecting part. The mirror body is mounted on the mirror base by means of this connecting part. Consequently, the overall height of the mirror base can be kept very small. The narrow section of the mirror body prevents wind noises from occurring, since the slip stream can easily flow past the narrow section without catching on parts of the exterior rearview mirror. Because of the inventive design, the exterior rearview mirror according to the invention has a favorable aerodynamic design. Moreover, the exterior rearview mirror has a light and small appearance because of the narrow section.

Additional features of the invention are apparent from the other claims, the description, and the drawings.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail on the basis of an example embodiment shown in the drawings. The drawings show:

FIG. 1, a rear view of an inventive exterior rearview mirror,

FIG. 2, a front view of the inventive exterior rearview mirror,

FIG. 3, the mirror body of the inventive exterior rearview mirror in an end view.

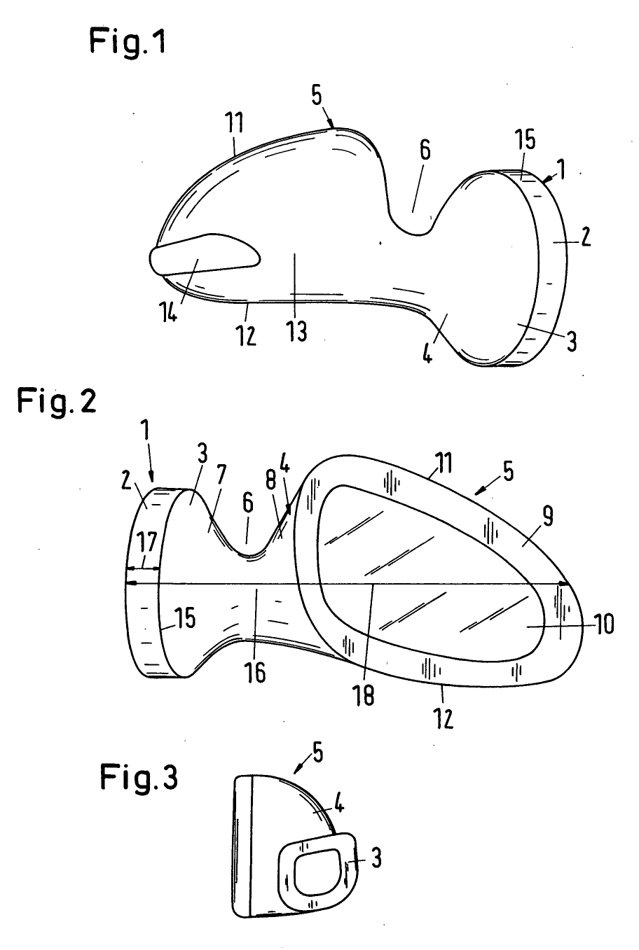

### DETAILED DESCRIPTION OF THE PREFERRED EMBODIMENTS

The exterior rearview mirror is intended for motor vehicles and has a mirror base 1 with a mounting part (not shown) by which the exterior rearview mirror is mounted on the motor vehicle. It has a circumferential sealing element 2, which surrounds and seals the mirror base 1 in the installed position. The mirror body is fastened to the mirror base 1 by means of a connecting part 3, which is designed as a single piece with a housing 4 of a mirror body 5. The outer contour of the connecting part 3 is matched to the sealing element, so both parts have the same outer contour. The connecting part 3 is designed as a hollow body which transitions into the housing 4 of the mirror body 5 through a circumferential indentation or narrow section 6. The indentation 6 is bounded by side walls 7, 8 of the connecting part 3 and of the housing 4. The two side walls 7, 8 enclose an angle of less than 45° and are curved to join one another in an arc. The depth of the indentation 6 is advantageously greater than its maximum width. These dimensions result in a very slender and deep narrow section at the transition from the housing 4 to the connecting part 3. This narrow section is located in the half of the exterior rearview mirror that faces the motor vehicle.

The housing 4 of the mirror body 5 tapers toward the end facing away from the vehicle. The housing 4 has a receiving space 9, in which a mirror glass bracket (not shown) for a mirror glass 10 is accommodated. The upper edge 11 bounding the receiving space 9 is continuously curved downward at an angle toward the bottom. In this context, this edge 11 has the greatest height above the bottom at the transition to the groove-like indentation 6. The bottom edge 12 of the housing 4 bounding the receiving space 9 likewise runs at an angle toward the ground, but at a much smaller angle than the upper edge. The two edges 11, 12 are continuously curved at the outer end to join one another. As can be seen from FIG. 3, the mirror body housing 4 is designed with a concave curvature toward the front in the direction of travel from the side delimiting the receiving opening for the mirror glass 10. In this way, the mirror body 5 has a favorable aerodynamic shape, which largely avoids wind noises.

Located in the side 13 of the housing 4 facing forward in the direction of travel is an optical window 14 of a turn signal repeater lamp, which is accommodated in the housing 4. The optical window 14 extends from the end of the housing 5 furthest from the vehicle toward the mirror base 1. In the example embodiment, the optical window 14 extends over approximately half the length of the housing 5. The optical window can have any suitable outer contour. The optical window can be made of a light-transmissible window of plastic, but can also be made of an optical waveguide material.

The mirror body 5 can be folded with respect to the mirror base 1 both in and opposite the direction of travel. As the folding mechanism, all known designs may be used, such as ball joints, intermediate joints, and the like. In this context, the folding motion in and opposite the direction of travel can take place about one axis (single-axis mirror) or about two axes (dual-axis mirror). The pivot axis (axes) is (are) located in the mirror base 1.

The folding motion in this context takes place in the region between the sealing element 2 and the connecting part 3. Since the mirror base 1 has only a slight thickness, the interface 15 is located very close to the vehicle body. In this way, wind noises are eliminated optimally. The indentation 6 designed in the form of the narrow section also plays a contributing role here. As a result of the indentation 6, there is formed between the housing 4 and the connecting part 3, a narrow web 16 with a round, hollow cross-section, which the slip stream can easily flow past. The web 16 is located closer to the bottom edge 11 than the top edge 10 of the housing 4. For this reason, the indentation 6 has a greater depth in the upper region with respect to the operating position of the mirror body 5 than in the lower region. Since the side walls 7, 8 of the indentation 6 have a continuous curve not only in cross-section, but also in the circumferential direction, the slip stream is diverted optimally with regard to aerodynamics. As a result of the design described, no air turbulence, which would result in noise, is produced in the region between the connecting part 3 and the housing 4. In addition, dirtying of the side windows of the motor vehicle, which is otherwise observed with turbulence, is also avoided by this means.

Finally, the vibrations of the mirror glass 10 and of the mirror body 5 are at least significantly reduced because of the optimal flow of the slip stream.

The sealing element 2, and thus the mirror base 1, have a height 17, which is approximately one tenth to approximately one twentieth the width 18 of the exterior rearview mirror (FIG. 2).

The description of the invention is merely exemplary in nature and, thus, variations that do not depart from the gist of the invention are intended to be within the scope of the invention. Such variations are not to be regarded as a departure from the spirit and scope of the invention.

What is claimed:

1. Exterior rearview mirror for vehicles, comprising a mirror base and a mirror body, which is foldable relative to the mirror base and has a housing, wherein the housing transitions through a narrow section into a connecting part to the mirror base.

2. Exterior rearview mirror according to claim 1, wherein the connecting part is joined in an articulating manner to a mounting part of the mirror base.

3. Exterior rearview mirror according to claim 1, wherein the narrow section is bounded by side walls that have a continuous curve in a circumferential direction.

4. Exterior rearview mirror according to claim 3, wherein the side walls of the narrow section curve in cross-section.

5. Exterior rearview mirror according to claim 1, wherein the narrow section has a depth at least equal to, or greater than, a maximum width of the narrow section.

6. Exterior rearview mirror according to claim 2, wherein the height of the mirror base is approximately one tenth to approximately one twentieth the width of the exterior rearview mirror.

7. Exterior rearview mirror according to claim 1, wherein the housing and the connecting part are joined to one another by means of a web.

8. Exterior rearview mirror according to claim 7, wherein the web is a shorter distance away from the underside of the housing than from its upper side.

9. Exterior rearview mirror, in particular according to claim 1, wherein the mirror base has a mounting part for attachment to the vehicle and has a connecting part, which is a component of the housing of the mirror body.

10. Exterior rearview mirror according to claim 1, wherein the narrow section is provided in a half of the exterior rearview mirror that faces the motor vehicle.
